(19) United States
(12) Patent Application Publication
(10) Pub. No.: US 2026/0135823 A1
(43) Pub. Date: May 14, 2026

(54) AUTOMATIC FUNCTION TAGGING IN A CLOUD-BASED 5G MOBILE TELEPHONE NETWORK

(71) Applicant: DISH Wireless L.L.C., Englewood, CO (US)

(72) Inventors: Steven Wilson, Englewood, CO (US); Brian Peletz, Aurora, CO (US)

(73) Assignee: DISH Wireless L.L.C., Englewood, CO (US)

(21) Appl. No.: 19/032,385

(22) Filed: Jan. 20, 2025

Related U.S. Application Data
(60) Provisional application No. 63/623,058, filed on Jan. 19, 2024.

(51) Int. Cl. H04L 47/70

(52) U.S. Cl. CPC H04L 47/82

(57) ABSTRACT

Computing systems, devices and automated processes are described for automatically tagging new functions prior to deployment in a cloud-based telecommunications system, such as a 5G wireless network implemented in accordance with an open radio access network (ORAN) specification. The automated processing evaluates the new function to identify one or more attributes of the new function relating to the ORAN that can be used to generate a tag. The tag can be used during subsequent operation to filter, identify or otherwise access functions for execution by particular components of the cloud-based telecommunication system.

### PRIORITY CLAIM

This application claims the benefit of U.S. Provisional Application No. 63/623,058 filed on Jan. 19, 2024 and entitled, “AUTOMATIC FUNCTION TAGGING IN A CLOUD-BASED 5G MOBILE TELEPHONE NETWORK,” which is incorporated herein by reference.

### TECHNICAL FIELD

The following generally relates to wireless data networks, such as 5G wireless networks. More particularly, the following relates to systems, devices and automated processes to automatically tag functions used to implement a wireless data network in a cloud-based computing environment that implements a wireless data network.

### BACKGROUND

Wireless networks that transport digital data and telephone calls are becoming increasingly sophisticated. Currently, fifth generation (“5G”) broadband cellular networks are being deployed around the world. These 5G networks use emerging technologies to support data and voice communications with millions, if not billions, of mobile phones, computers and other devices. 5G technologies are capable of supplying much greater bandwidth than was previously available, so it is likely that the widespread deployment of 5G networks could radically expand the number of services available to customers.

Traditionally, data and telephone networks relied upon proprietary designs based upon very specialized hardware and dedicated point-to-point data connections. More recently, industry standards such as the Open Radio Access Network (“Open RAN” or “O-RAN”) standard have been developed to describe interactions between the network and various client devices. The O-RAN model follows a virtualized wireless architecture in which 5G base stations (“gNBs”) are implemented using separate centralized units (CUs), distributed units (DUs) and radio units (RUs), along with various control planes that provide additional network functions (e.g., 5G Core, IMS, OSS/BSS/IT). Generally speaking, it is still necessary to implement the RUs with physical transmitters, antennas and other hardware located onsite within broadcast range of the end user's device.

Other components of the network, however, can be implemented using a more centralized architecture based upon cloud-based computing resources, such as those available from Amazon Web Services (AWS) or the like. This provides much better network management, scalability, reliability and redundancy, as well as other benefits. O-RAN CUs, DUs, control planes and/or other components of the network can now be implemented as software modules executed by distributed (e.g., “cloud”) computing hardware. Other network functions such as access control, message routing, security, billing and the like can similarly be implemented using centralized cloud computing resources. Often, a CU, DU, control plane or other component of the RAN network is created in software for execution by one or more virtual computers operating in parallel within the cloud environment.

Unlike traditional wireless networks that scaled through the addition of physical routers, switches and other hardware, RAN networks can scale upwardly and downwardly very quickly as new cloud-based services are deployed and/or existing services are retired or redeployed. Additional network components can be very quickly deployed, for example, through the use of virtual components executing in a cloud environment that can be very quickly duplicated and spawned as needed to support increased demand. Similarly, virtual components can be de-commissioned very quickly with very little cost or effort when network capacity allows. The virtual components provide substantial efficiencies, especially when compared to prior networks that were based upon complex interconnections between geographically dispersed routers, servers and the like.

The use of virtualized hardware provides numerous benefits in terms of rapid deployment and scalability, but it also presents certain technical challenges that have not been encountered in more traditional wireless networks. One technical challenge that arises in the new networks involves the development, deployment and maintenance of new functions. Due to the massively inter-related nature of the 5G network system, it is very important that newly designed functions be able to seamlessly integrate with other operations of the network. It is also desirable that the newly-designed functions be quickly identifiable during operation, particularly during updates and other system changes.

Software deployment has existed in various forms for some time. But the unique challenges of a large telecommunications network deployed in a cloud environment create a particular need for specialized deployment and tracking processes and systems. A substantial desire therefore exists to build systems, devices and automated processes that allow for automated tagging of functions in cloud-based 5G wireless networks. These and other features are described in increasing detail below.

### BRIEF SUMMARY

According to various embodiments, systems, devices and/or automated processes provide for automated tagging of functions deployed in a cloud-based telecommunications system, such as a 5G wireless network in accordance with ORAN specifications.

In one example, a cloud-based data processing system implements a 5G wireless network using one or more processors, non-transitory data storage and other appropriate data processing hardware. The data processing system suitably comprises a plurality of component systems each executing on the data processing hardware, an integration system executing on the data processing hardware, and a data repository. Each of the component systems executes one or more of a plurality of functions on the data processing hardware to implement the 5G wireless network. The integration system initially receives a new function for inclusion in the plurality of functions and performs an automatic evaluation of the new function to determine one or more tags for the new function, wherein each of the one or more tags describes an attribute of the new function related to the 5G wireless network. The data repository is configured to store the new function according to the one or more tags determined for the new function. The automatically-determined tags can be used for subsequent filtering and retrieval of functions in the data repository to thereby facilitate operations of the 5G wireless network. The particular attributes of the new function related to the 5G wireless network used to generate function tags could comprise any attributes of an open radio access network (ORAN) specification, if desired.

Other embodiments provide an automated process performed by a cloud-based data processing system having at least one processor and a non-transitory digital storage configured to store a plurality of functions that, when executed by the at least one processor, collectively implement a 5G wireless network. The automated process suitably comprises: receiving a new function for potential inclusion in the plurality of functions; performing an automatic evaluation of the new function to determine one or more tags for the new function, wherein each of the one or more tags describes an attribute of the new function related to the 5G wireless network; storing the new function in the non-transitory digital storage according to the determined one or more tags for the new function; and facilitating subsequent retrieval of the new function by at least one component of the 5G according to the determined one or more tags to thereby permit the at least one component of the 5G wireless network to implement the new function of the 5G wireless network.

Other embodiments provide data processing systems, devices and/or automated processes to automatically tag the various functions operating within a cloud data processing system, such as the data processing system used to implement a wireless 5G network. These and other example embodiments are described in increasing detail below.

### DRAWING FIGURES

FIG. 1 shows an example of a cloud-based wireless network system having integrated function tagging capabilities.

FIG. 2 illustrates one example of a data processing system for automatically tagging new functions in a cloud-based telecommunications system using an automated process.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

According to some embodiments, a centralized testing/validation system suitably includes automated processing for evaluating newly-received program functions prior to deployment in a 5G or similar wireless network. Functions are automatically evaluated to determine one or more “tags” that can describe attributes of the function relating to telecommunications system. ORAN or other 5G attributes, for example, can be evaluated and tagged as appropriate. If desired, such evaluation may occur within a “sandbox” computing environment such as a virtual private cloud (VPC) of a cloud-based data processing system that is logically isolated from the production VPCs used to implement the actual network, thereby permitting effective evaluation while isolating untested functions from those that have been cleared for use in the production environment. Other embodiments may perform automated tagging analysis of functions that have already been deployed, functions stored in a database or code repository, and/or any other functions as desired. Tagging analysis can be repeated, if desired, if the function is changed, to reflect additions or changes to the tagging nomenclature, and/or for any other purpose.

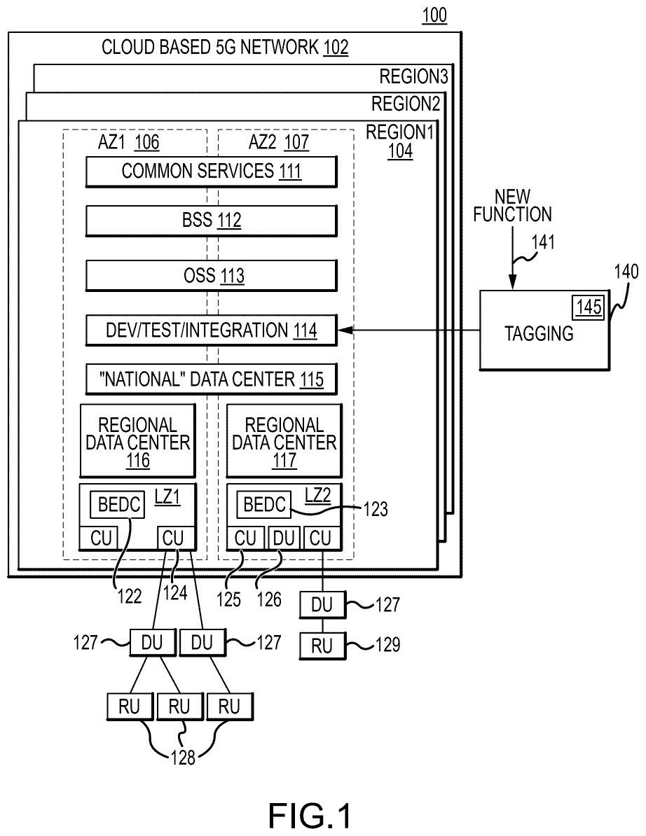

With reference to FIG. 1, a 5G wireless network 102 suitably includes development/test/integration (D/T/I) service 114 (also referenced herein as an “integration service 114”) that manages a software code base that implements the 5G network 102 within a cloud based computing environment. In the examples described below, D/T/I service 114 includes a tagging system 140 that receives new function 141 and that automatically “tags” or otherwise identifies the function by assigning an automatically-generated name to the function. Various embodiments of integration service 114 could also include a sandbox environment that allows the new functions to be evaluated to ensure compatibility, scalability, cloud-native functionality and other features prior to deployment of the new function within the production environment of system 102, if desired. Integration service 114 may include any alternate and/or additional features, as desired.

In contrast to most conventional networks that rely upon specialized hardware and numerous widely-distributed data centers, network 102 can be implemented using cloud-based computing resources such as those available from Amazon Web Services Inc. (AWS) of Seattle, Washington. Other cloud services are available from Microsoft Corp. of Redmond, Washington, IBM Corp. of Armonk, New York, and many others. The various functions and modules of the wireless network can be implemented within virtual private clouds (VPCs) or similar structures within the cloud computing environment. In the example of FIG. 1, network 102 encompasses virtualized data processing services supporting multiple regions 104, each having one or more availability zones (AZs) 106, 107 each acting as a separate data center with its own redundant power, network connectivity and other resources as desired. In some implementations, the various AZs operating within the same region will provide redundancy in the event that another AZ would fail, become overloaded, or otherwise become unavailable. The example of FIG. 1 illustrates three regions, with region 104 having two AZs 106, 107, although other embodiments could include any number of regions and AZs providing any number of services and resources. The regions and zones are often described herein with reference to geographic locations, but in practice the regions and zones could be equivalently organized based upon customer density, user density, expected network demand, availability of electric power and/or bandwidth, and/or any other factors. As noted above, it will generally be necessary to deploy radio units (RUs) within broadcast range of end users. By implementing the other functions of the network using virtualized hardware operating within a cloud-type architecture, however, geographic restrictions upon the network 102 can be greatly reduced. This can provide substantial efficiencies in deployment and expansion of network 102, while also allowing for more efficient use of computing resources, data storage and electric power.

In example system 100, a network operator maintains ownership of one or more radio units (RUs) 128, 129 associated with a wireless network cell. Each RU 128, 129 suitably communicates with user equipment (UE) operating within a geographic area using one or more antennas/towers capable of transmitting and receiving messages within an assigned spectrum of electromagnetic bandwidth. In various embodiments, the assigned spectrum may be allocated across one or more guest networks 1to support multiple concurrent networks, if desired.

The Open RAN standard breaks communications into three main domains: the radio unit (RU) 128, 129 that handles radio frequency (RF) and lower physical layer functions of the radio protocol stack, including beamforming; the distributed unit (DU) 127 that handles higher physical access layer, media access (MAC) layer and radio link control (RLC) functions; and the centralized unit (CU) 124, 125, 126 that performs higher level functions, including quality of service (QoS) routing and the like. CUs 124, 125, 126 may also support such features as packet data convergence protocol (PDCP), service data adaptation protocol (SDAP) and radio resource controller (RRC) functions. Examples of RU, DU and CU functions are described in more detail in the Open RAN standards, as updated from time to time, and may be modified as desired to implement the various functions and features described herein.

In the example illustrated in FIG. 1, common services (e.g., billing, guest network allocation, etc.) can be performed in a shared service 111 across the available AZs 106, 107. Typically, these shared services will be implemented within a common virtual private cloud (VPC) operating within the cloud environment. Similarly, shared VPC systems can support business support system (BSS) 112, operational support services (OSS) 113, development/test/integration features 114, and/or the like across the entire region.

As noted above, DTI service 114 appropriately includes a “tagging” environment 140 that can be used to evaluate various function 141 deployed within a production environment of system 100. To that end, tagging environment 140 typically supports various software or firmware modules 145 for performing various automated tests on the newly-received function 141, as described more fully herein. Tagging environment 140 may be implemented in a VPC or similar structure of the cloud environment. Equivalently, tagging environment 140 could be implemented in separate processing space, including conventional computer systems using physical hardware in any location.

The example network 102 illustrated in FIG. 1 includes one or more region wide data centers (e.g., “national” data center 115 in FIG. 1) that could be implemented in a shared VPC across AZs 106, 107 for the region, if desired, with subordinate data centers (e.g., “regional” data centers 116, 117) being separated into different VPCs for each of the AZs 106, 107. The various data centers could provide any number of services such as IP multimedia services (IMS), 5G core services and/or the like. Additional levels of data centers could be provided, if desired, and/or the different data center functions could be differently organized in any number of equivalent embodiments.

Each AZ 106, 107 in FIG. 1 includes one or more breakout edge data centers (BEDCs) 122, 123 each supporting a local zone (LZ) with one or more RUs 128, 129. The BEDCs are ideally organized for very low latency and high throughput to the various user equipment operating within the local zone. BEDCs 122, 123 will typically implement one or more CUs (e.g., CUs 124 and 125-126, respectively) in accordance with the O-RAN specifications. BEDCs 122, 123 may also implement user plane functions that handle user data sessions for gaming, streaming and other network services, as desired. Again, any number of BEDCs 122, 123 and other data centers may be implemented using any number of different or shared VPCs in the cloud environment 100, as desired.

Each RU 128, 129 is typically associated with a different wireless cell that provides wireless data communications to any number of user devices operating within broadcast range of the cell. RUs 128, 129 may be implemented with radios, filters, amplifiers and other telecommunications hardware to transmit digital data streams via one or more antennas. Generally, RU hardware includes one or more processors, non-transitory data storage (e.g., a hard drive or solid state memory) and appropriate interfaces to perform the various functions described herein. RUs are physically located on-site with the transmitter/antenna, as appropriate. Conventional 5G networks may make use of any number of wireless cells spread across any geographic area, each with its own on-site RU.

User devices are often mobile phones or other portable devices that can move between different cells associated with the different RUs, although 5G networks are also widely expected to support home and office computing, industrial computing, robotics, Internet-of-Things (IoT) and many other devices. While the example illustrated in FIG. 1 shows just a few RUs 128, 129 for convenience, a practical implementation will typically have any number of RUs that can each be individually configured to provide highly configurable geographic coverage for the 5G network 102.

Distributed units (DUs) 126, 127 suitably process baseband signals, including modulation, coding, beamforming and the like for one or more RUs 128, 129. If desired, some or all of the DUs 126, 127 could support multiple RUs 128, 129 and could coordinate activities between the two RUs, if desired. DUs 127 could be located, for example, at the base of a cell tower or the like. In some embodiments, DUs 126 could be implemented in virtual hardware with a local zone (e.g., LZ2 in FIG. 1) if desired. DUs 126, 127 generally communicate with a CU 124, 125 to exchange control information and to manage resource allocation, as desired.

As noted above, the various components of network 102 can be implemented using virtual private clouds (VPC) or other virtualized hardware components executing software or firmware instructions that are stored in a non-transitory data storage (e.g., a disk drive or solid state memory) for execution by one or more processors within the VPC. The cloud environment provides the opportunity to scale processing, data storage and bandwidth resources on an as-needed basis, thereby providing substantial efficiencies in comparison to previous network systems that relied upon specialized hardware spread across a large geographic area. VPCs may provide any number of additional features to support the data handling functions of system 102, including redundancy, scalability, backup, key management and/or the like.

The various functions that implement the components of system 102 may be created and managed in any manner. In one example, D/T/I system 114 manages a database or other repository of code that has been tested and found to be allowed within the production network 102. Before entering the repository of allowed code, new software functions are evaluated based upon various factors. While previous implementations often relied upon manual review by a human operator and/or rudimentary code analysis, an automated validation can provide much more effective and efficient review, thereby providing a more robust and secure software implementation. To that end, it can be very desirable to provide an automated analysis that can evaluate new functions, and that can verify that the new function is suitably container-based and cloud native prior to deployment in production systems.

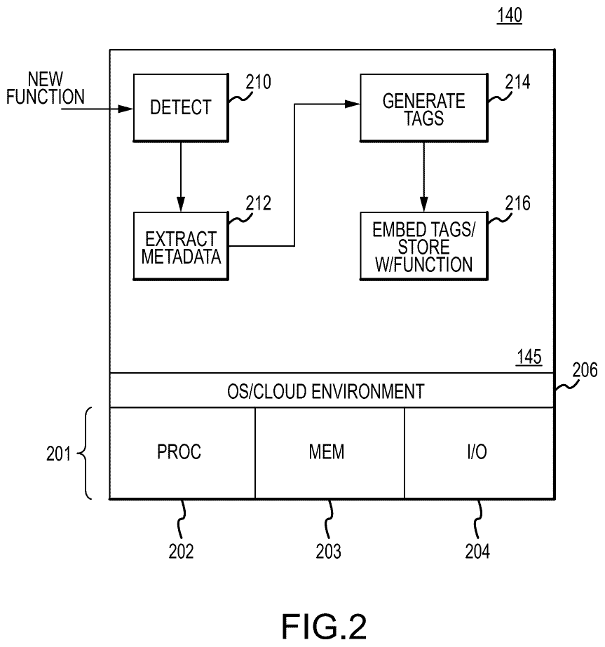

FIG. 2 shows one example of a tagging system 140 that could be implemented within D/T/I system 114 of wireless network 102, or in any other manner. With reference to FIG. 2, tagging system 140 suitably executes software or firmware instructions 145 to perform automated analyses 210, 212, 214, 216 of a newly received or other function 141. The function 141 is evaluated to identify attributes related to the 5G or other wireless network, and identified attributes are embedded as tags into the function itself, or its associated metadata as desired.

Tagging system 140 can be implemented using any available hardware 201, such as any sort of processor 202, solid state or other non-transitory data storage 203 and appropriate input/output interfaces 204. As noted above, tagging system 140 could be implemented on a personal computer, server or similar hardware with conventional processing, storage and interface capabilities. In other embodiments, tagging system 140 could be implemented using cloud-based hardware, such as one or more virtual private clouds (VPCs) associated with the Amazon Web Services (AWS) system, or any other cloud service as desired. In this case, an abstraction layer 206 provides operating system and similar capabilities to permit software 145 to execute and perform the desired functions using cloud-based hardware 201, as appropriate. Again, other cloud services other than AWS could be used, if desired.

In the example of FIG. 2, various sub-systems 210-216 provide automated functions to receive, evaluate and tag a function 141. Each of the sub-systems 210-216 may be implemented using software and/or firmware instructions that are compatible with abstraction layer 206 for storage in data storage 203 and execution by processor 202, as appropriate. The example functions 210-216 shown in FIG. 2 could be modified and/or supplemented in any manner to perform the various functions described herein.

In various embodiments, a detection system 210 appropriately determines when a new function 141 is available for tagging. Detection system 210 may be provided within an application program interface (API) or the like, if desired. Alternatively, detection system 210 could be automated using, for example, a daemon or similar software module executing within cloud environment 206. The AWS CloudWatch feature, for example, could be configured within an AWS Lambda or other service to detect when a new function is deployed or updated. In some implementations, AWS Cloudwatch Events or a similar service could be configured to trigger on a specific API call (e.g., CreateFunction or UpdateFunction) that creates or updates functions within environment 100, as desired. Other embodiments could use other services, including customized programming, to perform similar functions if desired.

When a function 141 is recognized for analysis, the function is identified to an analysis sub-system 212 that analyzes the function to identify the purpose of the function 141, as well as any other attributes relating to the wireless network system 100. In various embodiments, the function's code can be analyzed to determine calls to other functions or services to further ascertain the purpose and operation of the function 141 being analyzed. Analysis 212 may further consider any other available data, including any metadata provided by the programming entity, to further classify and identify the function 141 and its purpose.

System 140 therefore performs an automatic evaluation to identify the function 141, its purpose, and/or any attributes associated with the function. Attributes relating to the 5G or other wireless network may be of particular interest.

Tags can be generated in any manner. In the example of FIG. 2, sub-system 214 appropriately generates text or other tags that can be stored in association with the function 141 itself. In various embodiments, a “tag” is a label that can be assigned to a function or other resource. In one implementation using the AWS system, tags for each function are maintained within AWS Resource Group tags, which is provided by the AWS service and can be accessed through a published API. Software such as the Botos3 software available from Capital One could also be used to enhance tagging, if desired. These tools can be useful in implementation, but do not include tags or other features relevant to telecommunications or wireless networking.

Tags may be formatted in any manner. In one example, tags will include both a “key” and a “value”, with the key identifying the nature of the tag, and the value providing additional detail. If a system 100 includes two relatively identical functions, for example, the key for both instances could be the same (e.g., an identifier of the instance type), but the values would be different (e.g., “production” and “test”, “primary” and “secondary”, “first” and “second”, or any other values as desired). Other embodiments could be structured in any other manner.

Tags may be customized for 5G or other wireless networking, as desired. In various embodiments, tag keys could be formatted in a manner that uses patterns to determine how resources are consumed. A tag key could be formatted, for example, according to the following pattern:
[EncodingStandard]:[NetworkFunction]:[ClientName].
   In this example, “EncodingStandard” relates to “RAN” or the like, while the “NetworkFunction” describes the particular module of system 100 where the function is used, and “ClientName” identifies a client device or other element of the system 100 for additional reference. A tag key such as “RAN:DU:Client1”, for example, could identify a RAN function that allows a device provided by “Client1” to access a feature of a DU in system 100, for example. Other embodiments could structure tags, keys and values in any other manner desired.

The tags and values can be used for any purposes. A downstream process, for example, could use the tags to filter the various functions for updates or modifications, or for any other purpose. To that end, the generated tags are associated with the underlying function and stored for later reference. In FIG. 2, sub-system 216 performs the storage function as desired. As noted above, tags may be maintained within the tagging architecture provided by environment 206, if desired. Other embodiments could store the various tags in a database, or within the function 141 itself. In the latter instance, tags could be stored as comments or other non-executed code near the top of the function's source code, or at any other location where the tags could be subsequently found and processed.

Tags could be used for any other purposes. In some embodiments, components of the 5G wireless network 102 (e.g., DUs 127; CUs 124, 125, 126; BEDCs 122, 123 and/or the like) could use the automatically determined tags for filtering or otherwise identifying functions in a data repository or other database that are executable by the particular component. A DU 127, for example, could retrieve functions from the data repository by querying for functions having a “DU” identifier as part of their associated tag(s). Functions identified by their tags can be retrieved and executed as appropriate to implement one or more operations of the 5G wireless network 102, as desired.

Various embodiments therefore provide data processing systems, devices and/or automated processes to automatically tag functions deployed in a cloud-based telecommunications system, such as a 5G telephone network. Other embodiments may provide additional benefits and features, as desired.

The general concepts set forth herein may be adapted to any number of alternate but equivalent embodiments. The term “exemplary” is used herein to represent one example, instance or illustration that may have any number of alternates. Any implementation described herein as “exemplary” is not necessarily to be construed as preferred or advantageous over other implementations, nor is it necessarily intended as a model that must be duplicated in other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A cloud-based data processing system that implements a 5G wireless network using data processing hardware, the cloud-based data processing system comprising:
a plurality of component systems each executing on the data processing hardware, wherein each of the component systems executes one or more of a plurality of functions on the data processing hardware to implement the 5G wireless network;
an integration system executing on the data processing hardware that initially receives a new function for inclusion in the plurality of functions, wherein the integration system performs an automatic evaluation of the new function to determine one or more tags for the new function, wherein each of the one or more tags describes an attribute of the new function related to the 5G wireless network; and
a data repository associated with the 5G wireless network, wherein the data repository is configured to store the new function according to the one or more tags determined for the new function.

2. The cloud-based data processing system of claim 1 wherein the attribute of the new function related to the 5G wireless network comprises an attribute of an open radio access network (ORAN) specification.

3. The cloud-based data processing system of claim 1 wherein each of the plurality of functions is maintained in the data repository associated with the cloud-based data processing system.

4. The cloud-based data processing system of claim 3 wherein the data repository is a database maintained by the integration system on a non-transitory data storage device.

5. The cloud-based data processing system of claim 4 wherein at least one of the plurality of component systems is configured to access the database maintained by the integration system, to identify the new function according to the automatically-determined one or more tags associated with the new function, and to execute the identified new function to implement the 5G wireless network.

6. The cloud-based data processing system of claim 2 wherein the integration system is a development/test/integration (D/T/I) service that manages the plurality of functions as a software code base that implements the 5G wireless network.

7. The cloud-based data processing system of claim 6 wherein the software code base is a database maintained by the integration system on a non-transitory storage device.

8. The cloud-based data processing system of claim 7 wherein at least one of the plurality of component systems is configured to access the database maintained by the integration system, to identify the new function according to the automatically-determined one or more tags associated with the new function, and to execute the identified new function to implement the 5G wireless network.

9. The cloud-based data processing system of claim 1 wherein the automatically-determined tags are formatted according to a pattern that includes a first identification of an encoding standard, a second identification of a network function and a third indication of a client name.

10. The cloud-based data processing system of claim 9 wherein the second identification identifies the network function as a distributed unit (DU) of the 5G wireless network.

11. An automated process performed by a cloud-based data processing system having at least one processor and a non-transitory digital storage configured to store a plurality of functions that, when executed by the at least one processor, collectively implement a 5G wireless network, the automated process comprising:
receiving a new function for potential inclusion in the plurality of functions;
performing an automatic evaluation of the new function to determine one or more tags for the new function, wherein each of the one or more tags describes an attribute of the new function related to the 5G wireless network; and
storing the new function in the non-transitory digital storage according to the determined one or more tags for the new function;
facilitating subsequent retrieval of the new function by at least one component of the 5G according to the determined one or more tags to thereby permit the at least one component of the 5G wireless network to implement the new function of the 5G wireless network.

12. The automated process of claim 11 wherein the at least one component of the 5G wireless network is configured to access the non-transitory digital storage, to identify the new function according to the determined one or more tags associated with the new function, and to execute the identified new function to implement an operation of the 5G wireless network.

13. The automated process of claim 12 wherein the integration system is a development/test/integration (D/T/I) service that manages the plurality of functions as a software code base that implements the 5G wireless network.

14. The automated process of claim 11 wherein the one or more tags are formatted according to a pattern that includes a first identification of an encoding standard, a second identification of a network function and a third indication of a client name.

15. The automated process of claim 14 wherein the second identification identifies the network function as a distributed unit (DU) of the 5G wireless network.
